(19) United States
(12) Patent Application Publication
(10) Pub. No.: US 2016/0366384 A1
(43) Pub. Date: Dec. 15, 2016

(54) LIGHT SOURCE DEVICE AND PROJECTOR

(71) Applicant: SEIKO EPSON CORPORATION, Tokyo (JP)

(72) Inventors: Takahiro MIYATA, Matsumoto-Shi (JP); Fumihide SASAKI, Azumino-Shi (JP); Yukihiro HORIKO, Matsumoto-Shi (JP); Takahiro TAKIZAWA, Suzaka-Shi (JP)

(73) Assignee: SEIKO EPSON CORPORATION, Tokyo (JP)

(21) Appl. No.: 15/170,037

(22) Filed: Jun. 1, 2016

(30) Foreign Application Priority Data
Jun. 11, 2015 (JP) 2015-118087

(51) Int. Cl. H04N 9/31; G03B 21/20

(52) U.S. Cl. CPC H04N 9/3194; G03B 21/2086; H04N 9/3144; H04N 9/3164

(57) ABSTRACT

A light source device, which is incorporated into a projector and is used, includes a light source, and a light source case, in which the light source case includes fuses that are fused in a case where the light source device is in a predetermined use state, and a light source detection portion that detects whether or not the light source device is installed at a predetermined position in the projector. A projector includes a light source cartridge that is provided with a cartridge case accommodating two light source devices and corresponding to an installation posture of a projector main body, in which the cartridge case includes a cartridge detection portion that detects the corresponding installation posture.

### CROSS REFERENCE TO RELATED APPLICATION

The entire disclosure of Japanese Patent Application No. 2015-118087, filed Jun. 11, 2015 is expressly incorporated by reference herein.

### BACKGROUND

1. Technical Field

The present invention relates to a light source device and a projector having the light source device.

2. Related Art

In related art, there is a projector in which light (emitted light) emitted from a light source is modulated by a light modulation device according to image information, and is enlarged and projected by a projection optical device. In recent years, the projector has been widely used for an event or the like, and achievement of high luminance of the projector has further progressed. There is a case of using a plurality of light sources in order to achieve high luminance of the projector.

The number of agents lending out such a high luminance projector to organizers of events has increased.

Regarding a posture (installation posture) of a projector during projection, the projector is installed on a desk or a ceiling (or installed similarly thereto) as a normal installation posture, and has recently performed projection while changing an installation posture thereof.

JP-A-2011-22304 discloses a projector in which a replacement light source with a fuse which is fused during lighting of the light source can be checked to be lighted without fusing the fuse when the replacement light source is checked to be lighted in a store or the like which sells the projector.

In a case where an installation posture of a projector is changed, a posture of a light source accommodated in the projector is also changed, and thus it is hard to cool the light source due to heat generated from the light source depending on an installation posture. Therefore, there is a problem in that the service life of the light source is considerably reduced.

Since the service life of the light source greatly differs depending on installation posture, in order for an agent or the like lending out a projector to understand a replacement time of the light source, it is important to view and recognize in which posture the light source was used when the projector is rented, or to view and recognize in which posture a light source was previously used when the light source which was used once but whose service life is not expired, is rented.

Also for a user using a projector, in the same manner as the rental agent, in order to understand a replacement time of a light source, it is important to view and recognize an installation posture in which the light source was used. When a projector is used, it is desirable to check whether or not a light source corresponding to a desired installation posture of the projector is provided,

Therefore, there is a demand for a light source device and a projector having a configuration in which an installation posture of a light source (an installation posture of a projector) when the light source was used can be recognized, or a configuration in which it can be checked whether or not a light source corresponding to an installation posture of a projector is provided.

### SUMMARY

An advantage of some aspects of the invention is to solve at least a part of the problems described above, and the invention can be implemented as the following forms or application examples.

### Application Example 1

A light source device according to this application example is incorporated into a projector including a cooling device sending cooling air and is used, and includes a light source; and a light source case that accommodates the light source, in which the light source case includes a plurality of fuses that are fused in a case where the light source device is in a predetermined use state; and a light source detection portion that detects whether or not the light source device is installed at a predetermined position in the projector.

According to the light source device, it is possible to understand an installation posture of the light source device when the light source device was used by visually checking which fuse is fused among a plurality of fuses. Since the light source detection portion detects whether or not the light source device is installed at a predetermined position in the projector, it is possible to detect whether or not the light source device is accurately installed.

### Application Example 2

A projector according to this application example includes a light modulation device that modulates light emitted from a light source; a projection optical device that projects the light modulated by the light modulation device; and a plurality of light source cartridges that include the light source device described above, and a cartridge case accommodating a plurality of the light source devices and corresponding to an installation posture of a projector main body, in which the cartridge case includes a cartridge detection portion that detects the corresponding installation posture.

According to the projector, in the light source cartridge, a plurality of light source devices are accommodated in the cartridge case corresponding to an installation posture of the projector main body. The projector includes a plurality of light source cartridges. The cartridge detection portion detects a corresponding installation posture of the light source cartridge. Thus, it is possible to determine whether or not a light source cartridge corresponding to an installation posture of the projector is installed on the basis of a detection result in the cartridge detection portion, and, for example, a result of obtaining information regarding the installation posture of the projector.

In a case of using the light source cartridges, a fused fuse of the light source device accommodated in the light source cartridge is checked, and thus it is possible to understand in which posture the light source device (light source cartridge) was used previously.

### Application Example 3

It is preferable that the projector according to the application example further includes a controller that controls an operation of the projector main body on the basis of results detected by the light source detection portion and the cartridge detection portion; and a notification portion that performs a notification based on a process performed by the controller.

According to the projector with this configuration, the notification portion performs a notification of a result of a process performed by the controller on the basis of results detected by the light source detection portion and the cartridge detection portion. Therefore, for example, a user can check whether or not the light source device is installed, and whether or not the light source cartridges corresponding to an installation posture of the projector are installed, via the notification portion.

### Application Example 4

It is preferable that the projector according to the application example further includes a fusing circuit that fuses the fuse; an input operation portion that receives an operation for operating the fusing circuit; and a controller that gives an instruction for fusing the fuse corresponding to the installation posture to the fusing circuit on the basis of a result detected by the cartridge detection portion and an input operation from the input operation portion.

According to the projector with this configuration, the projector includes the fusing circuit, and the input operation portion, and the controller gives the fusing circuit an instruction for fusing a fuses corresponding to an installation posture on the basis of a result detected by the cartridge detection portion and the input operation from the input operation portion. Consequently, the user can check whether or not the light source cartridges corresponding to an installation posture of the projector are installed. In a case where a corresponding light source cartridge is installed, the fuse corresponding to the installation posture can also be fused.

### Application Example 5

In the projector according to the application example, it is preferable that the installation posture includes a normal installation posture corresponding to on-desk installation or hanging installation, and a side installation posture obtained by rotating the normal installation posture by about 90° with respect to an optical axis of light emitted from the projection optical device.

According to the projector with this configuration. an appropriate light source cartridge can be installed in the normal installation posture and the side installation posture so as to perform projection. For example, a horizontally long image (for example, a lateral image with the A4 size) can be projected in the normal installation posture without being reduced, and a vertically long image (for example, a longitudinal image with the A4 size) can be projected in the side installation posture without being reduced.

### Application Example 6

In the projector according to the application example, it is preferable that the cartridge detection portion and the light source detection portion are configured to include electrical resistive elements.

According to the projector with this configuration, the cartridge detection portion and the light source detection portion are configured to include electrical resistive elements, and thus it is possible to easily configure the cartridge detection portion and the light source detection portion.

### BRIEF DESCRIPTION OF THE DRAWINGS

The invention will be described with reference to the accompanying drawings, wherein like numbers reference like elements.

FIGS. 1A and 1B are schematic perspective views illustrating installation postures of a projector when the projector performs projection according to the present embodiment.

FIG. 2 is a block diagram illustrating a schematic configuration of the projector.

FIGS. 3A and 3B are perspective views illustrating an exterior of a light source device.

FIG. 4 is a perspective view illustrating an exterior of a light source cartridge.

FIG. 5 is a flowchart illustrating an operation after the light source cartridge is attached to the projector.

FIGS. 6A and 6B are flowcharts illustrating a case where the light source cartridges for a normal installation posture are installed on both sides.

FIGS. 7A and 7B are flowcharts illustrating a case where the light source cartridges for a side installation posture are installed on both sides.

FIG. 8 is a flowchart illustrating a case where the light source cartridges for different installation postures are installed on each side, and an installation posture of the projector is the normal installation posture.

FIG. 9 is a flowchart illustrating a case where the light source cartridges for different installation postures are installed on each side, and an installation posture of the projector is the side installation posture.

### DESCRIPTION OF EXEMPLARY EMBODIMENTS

Hereinafter, an embodiment will be described with reference to the drawings.

### Embodiment

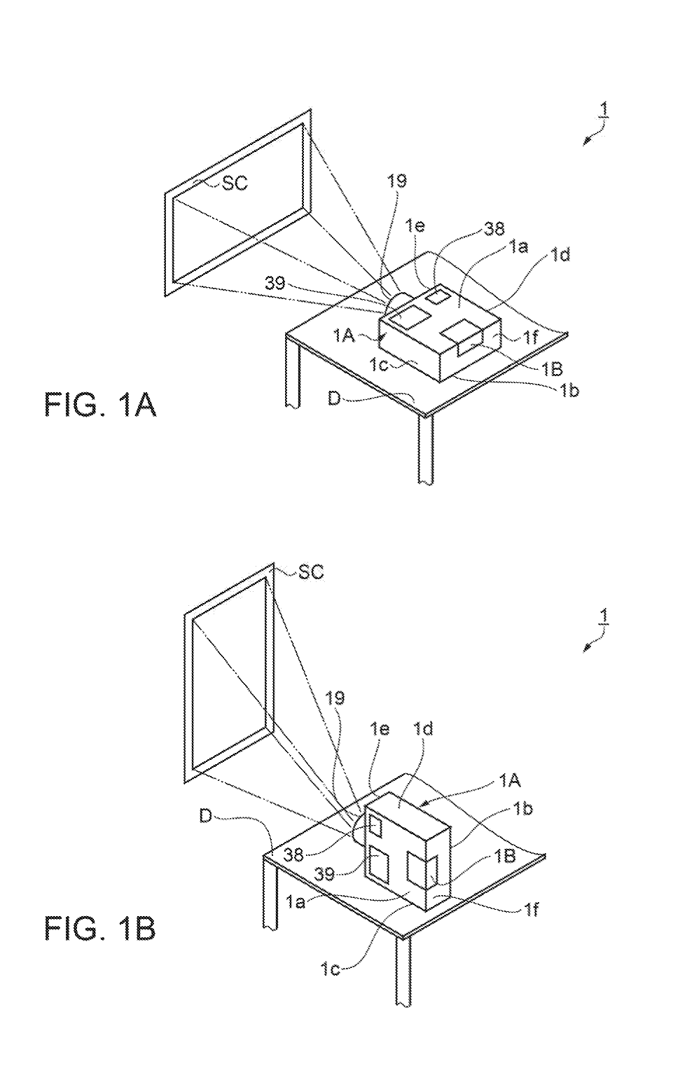

FIGS. 1A and 1B are schematic perspective views illustrating an installation posture of a projector 1 when projection is performed by using the projector 1 according to the present embodiment, in which FIG. 1A illustrates a normal installation posture, and FIG. 1B illustrates a side installation posture. With, reference to FIGS. 1A and 1B, a description will be made of an installation posture when projection is performed by using the projector 1.

The projector 1 of the present embodiment modulates light emitted from a light source device 10 (light source 11) with a light modulation device according to image information, and enlarges and projects the modulated light on a screen SC or the like via a projection optical device 19. The projector 1 of the present embodiment is used to perform projection in two ways of installation postures including a normal installation posture illustrated in FIG. 1A and a side installation posture illustrated in FIG. 1B.

The projector 1 is roughly formed in a hexahedral box shape as illustrated in FIGS. 1A and 1B. Here, as illustrated in FIG. 1A, with a case where the projector 1 is installed in the normal installation posture as a reference, in relation to an external casing 1A of the projector 1, an upper surface is indicated by 1a, a lower surface is indicated by 1b, left and right surfaces are respectively indicated by 1c and 1d, a front surface on which the projection optical device 19 is provided is indicated by 1e, and a rear surface is indicated by 1f. A direction in which the projection optical device 19 performs projection is a frontward direction.

In the present embodiment, as illustrated in FIG. 1A, the normal installation posture is an installation posture in which a projector is generally installed in the related art, and indicates an installation posture (so-called on-desk installation posture) in which the lower surface 1b of the projector 1 is located on a lower side, and the projector 1 is installed on a desk surface D, or an installation posture (so-called hanging installation posture) in which the projector 1 is installed on a ceiling surface (not illustrated) using a jig by reversing upper and lower sides thereof and performs projection.

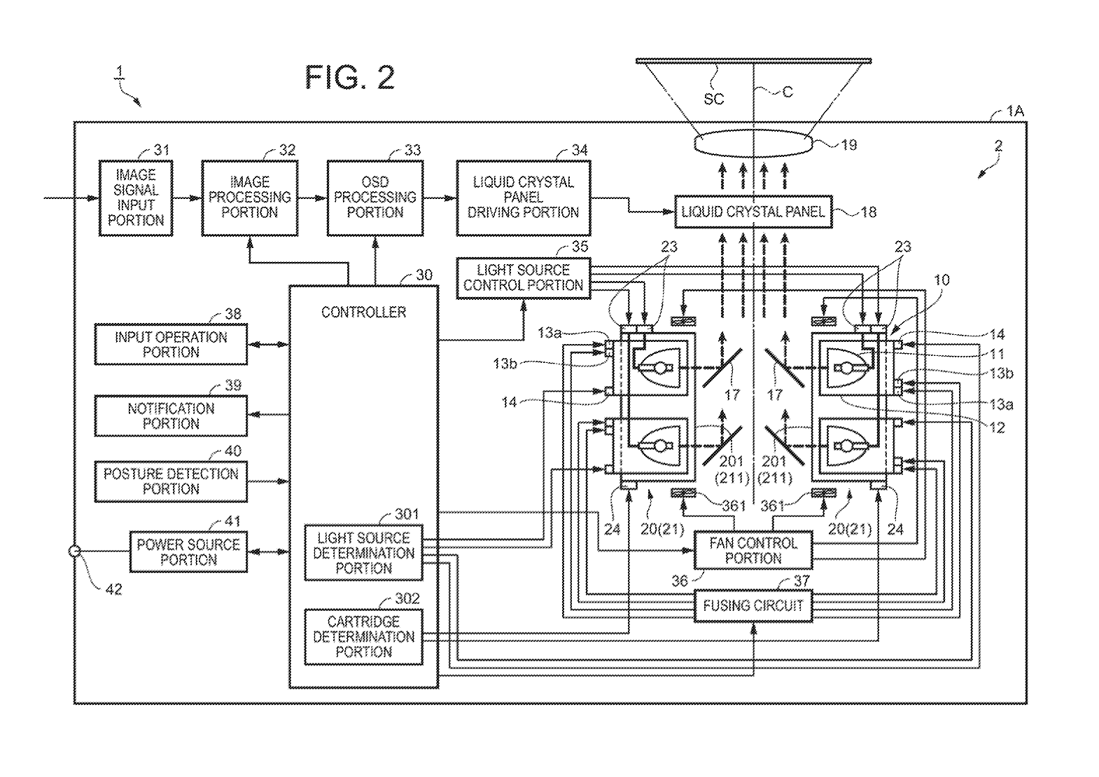

When compared with the normal installation posture, as illustrated in FIG. 1B, the side installation posture is an installation posture in which the projector 1 is rotated nearly by 90° with respect to an optical axis C (FIG. 2) of light emitted from the projection optical device 19, and the projector 1 performs projection in a state in which the left surface 1c is placed on the desk surface D. In the present embodiment, as illustrated in FIG. 1A, in a case where projection is performed in the normal installation posture, a horizontally long image (for example, an image of an aspect ratio of 4:3) is projected. As illustrated in FIG. 1B, in a case where projection is performed in the side installation posture, a vertically long image (for example, an image obtained by rotating an image of an aspect ratio of 4:3 by about 90° is projected.

An input operation portion 38 provided with various keys for performing input operations, a notification portion 39 notifying a user of a processing result, and the like are installed on the upper surface la of the projector 1. A cover member 1B which is attached and detached when light source cartridges 20 and 21 (FIG. 2) will be described later are replaced is provided from the upper surface 1a to the rear surface 1f. An image signal input portion 31 (FIG. 2) (not illustrated) for inputting an image signal is provided on both sides of the cover member 1B of the rear surface 1f.

FIG. 2 is a block diagram illustrating a schematic configuration of the projector 1. FIG. 2 illustrates circuit blocks constituting the projector 1, and an optical system 2 including the light source device 10, the light source cartridges 20 and 21, and the like according to the present embodiment. FIG. 2 is a diagram in a plan view in which the lower surface 1b side is substantially viewed from the upper surface 1a side of the projector 1 in the optical system 2 in a case where the normal installation posture is used as a reference. With reference to FIG. 2, a description will be made of a circuit configuration and the optical system 2 of the projector 1.

The projector 1 includes the optical system 2, a controller 30, the image signal input portion 31, an image processing portion 32, an OSD processing portion 33, a liquid crystal panel driving portion 34, a light source control portion 35, a fan control portion 36, a fusing circuit 37, an input operation portion 38, a notification portion 39, a posture detection portion 40, a power source portion 41, and the like.

The optical system 2 is operated under the control of the controller 30, and forms image light according to image information. The optical system 2 includes the light source device 18 (the light source cartridges 20 and 21 provided with the light source device 10) provided with the light sources 11, reflection mirrors 17 which reflect light emitted from the light source device 10 forward, a liquid crystal panel 18 as a light modulation device, the projection optical device 19, and the like.

The projector 1 of the present embodiment is constituted of the optical system 2 using four light sources 11. High luminance of the projector 1 is achieved by using the four light sources. As the light source 11, in the present embodiment, a discharge type lamp is used, and, specifically, an ultra-high pressure mercury lamp, a metal halide lamp, or the like is used. The four light sources 11 are opposite to each other in the leftward-and-rightward direction with respect to the reflection mirrors 17, and two light sources are disposed in parallel on each side.

The four light sources 11 have the same specification regardless of an installation posture of the projector 1. The light source 11 is accommodated in a light source case 12 which will be described later so as to constitute the single light source device 10. Therefore, in the present embodiment, four light source devices 10 are used. The four light source devices 10 have the same configuration regardless of an installation posture of the projector 1.

Among the four light source devices 10, two light source devices 10 are accommodated in cartridge cases 201 and 211 which are formed to correspond to an installation posture which will be described later so as to constitute the light source cartridges 20 and 21 corresponding to the installation posture. The light source cartridges 20 and 21 are configured to correspond to an installation posture of the projector 1. In the present embodiment, in relation to the light source cartridges, a light source cartridge corresponding to the normal installation posture is given the reference numeral 20, and a light source cartridge corresponding to the side installation posture is given the reference numeral 21. Therefore, in the present embodiment, two types of light source cartridges 20 and 21 are used to correspond to installation postures.

In the present embodiment, as illustrated in FIGS. 1A and 2, in a case where the normal installation posture is used as a reference, the light source cartridges are installed in the leftward-and-rightward direction. Thus, for example, the light source cartridges 20 for the normal installation posture are configured as left and right light source cartridges 20. Specifically, regarding the light source cartridges 20, the left light source cartridge is given the reference numeral 20a, and the right light source cartridge is given the reference numeral 20b.

Therefore, in a case where the projector 1 is used in the normal installation posture, in the light source cartridges 20 for the normal installation posture, the left light source cartridge 20a is installed on the left side, and the right light source cartridge 20b is installed on the right side. The projector 1 is installed in the normal installation posture (in which the lower surface 1b is placed on the desk surface).

Similarly, in a case where the projector 1 is used in the side installation posture, in the light source cartridges 21 for the side installation posture, the left light source cartridge 21a is installed on the left side, and the right light source cartridge 21b is installed on the right side. The projector 1 is installed in the side installation posture (in which the left surface 1c is placed on the desk surface D). Here, in a case where the projector 1 is installed in the side installation posture, the left surface 1c is placed on the desk surface D, and thus a state occurs in which the left light source cartridge 21a is installed on the lower side, and the right light source cartridge 21b is installed on the upper side.

In the present embodiment, in a came where the light source cartridges 20 and 21 for different installation postures are respectively installed on the left and right sides, the light source cartridges 20 and 21 corresponding to an installation posture of the projector 1 can be selected and lighted. In this case, the luminance of the projector 1 is reduced by half since two light source devices 10 are used.

Details of the light source device 10 and the light source cartridge 20 will be described later.

Hereinafter, a description will be made of an operation of the optical system 2 assuming that the projector 1 is installed in the normal installation posture, and the light source cartridges 20 corresponding to the normal installation posture are installed on the left and right sides. As will be described later in detail, in a case where the light source device 10 is lighted by the light source control portion 35, a fuse 13a for normal installation posture, which will be described later, provided in each light source device 10, is fused by the fusing circuit 37 before lighting the light source device 10 if the light source device 10 is used for the first time.

In a case where light is emitted due to lighting of the four light source devices 10, the emitted light is reflected forward by the reflection mirror 17 provided to correspond to each light source device 10. The illuminance of reflected light is uniformized (light beams) by a lens integrator optical system (not illustrated), and the light is then incident to the liquid crystal panel 18.

The liquid crystal panel 18 is constituted of a transmissive liquid crystal panel in which liquid crystal is enclosed between a pair of transparent substrates. In the liquid crystal panel 18, if a driving voltage corresponding to an image signal is applied to each pixel due to driving performed by the liquid crystal panel driving portion 34, each pixel transmits light therethrough with light transmittance corresponding to the image signal.

The light emitted from the light source device 10 is modulated as a result of being transmitted through the liquid crystal panel 18, and the modulated light is projected by the projection optical device 19. Therefore, as illustrated in FIG. 1A, an image corresponding to the image signal is projected on the screen SC or the like.

The controller 30 includes a central processing unit (CPU), and nonvolatile memories (not illustrated) such as a RAM, a mask, ROM, a flash memory, and a ferroelectric RAM (FeRAM) used to temporarily store various data, and thus functions as a computer. The controller 30 collectively controls an operation of the projector 1 by the CPU being operated according to a control program stored in the nonvolatile memory.

The controller 30 includes a light source determination portion 301 which determines whether or not the light source device 10 is installed at a predetermined posit ion in the projector 1. In addition, the controller 30 includes a cartridge determination portion 302 which determines a corresponding installation posture of the installed light source cartridges 20 and 21.

The light source determination portion 301 operates a light source detection portion 14 provided in each light source device 10 on the basis of an instruction from the controller 30, so as to determine the presence or absence of the light source device 10. The light source detection portion 14 includes, specifically, an electrical resistive element. The light source determination portion 301 determines the presence or absence of the light source device 10 by making a current flow through the light source detection portion 14 so as to detect output therefrom.

The cartridge determination portion 302 operates a cartridge detection portion 24 provided in each of the light source cartridges 20 and 21 on the basis of an instruction from the controller 30 so as to determine corresponding installation postures of the installed light source cartridges 20 and 21. The cartridge detection portion 24 includes, specifically, an electrical resistive element. The cartridge determination portion 302 determines corresponding installation postures of the light source cartridges 20 and 21 by making a current flow through the cartridge detection portions 24 so as to detect an output difference.

The input operation portion 38 includes a plurality of keys and the like for receiving various input operations on the projector 1. As the keys included in the input operation portion 38, there are a “power key” for turning on and off a power source, an “input switching key” for switching an input source, a “menu key” for switching display and non-display of a menu screen used to perform various settings, a “cursor key” used to move a cursor on the menu screen, a “determination key” for determining various settings, and the like.

If a user operates the input operation portion 38, the input operation portion 38 outputs an operation signal corresponding to the user's operation content to the controller 30. The input operation portion 38 may be configured to include a remote control signal reception portion (not illustrated) and a remote controller (not illustrated) which can perform remote control. In this case, the remote controller emits an operation signal such as infrared rays corresponding to the user's operation content, and the remote control signal reception portion receives the operation signal which is then sent to the controller 30.

In the present embodiment, the notification portion 39 is constituted of a liquid crystal panel, and displays an image such as a menu screen or a message screen on the basis of an instruction from the controller 30.

The light source control portion 35 controls the supply and stoppage of power to the light source device 10 via connector's 23 provided in the light source cartridges 20 and 21 on the basis of an instruction from the controller 30, and thus switches lighting and putting-out of the light source 11.

The fan control portion 36 controls an intake fan and an exhaust fan (not illustrated). The fan control portion 36 controls four cooling fans 361 which are provided over the light source devices 10 in the normal installation posture so as to correspond to the respective light source devices 10, and introduce cooling air into the light source devices 10 (light sources 11) from the top of the light source devices 10 so as to cool the light sources 11. A cooling device sending cooling air is constituted of the fan control portion 36, the intake fan, the exhaust fan, and the cooling fans 361.

The fusing circuit 37 applies a fusing current to fuses (the fuse 13a for normal installation posture and a fuse 13b for side installation posture) provided in each light source device 10 on the basis of an instruction from the controller 30. If the fusing current is applied by the fusing circuit 37, the fuses 13a and 13b are fused.

The posture detection portion 40 detects an installation posture of the projector 1. The posture detection portion 40 is constituted of a four-direction sensor which detects upper, lower, left and right postures of the projector 1, and outputs a determination result to the controller 30.

The image signal input portion 31 is provided with various image input terminals for connection to external image supply devices (not illustrated) such as a personal computer, a video reproduction device, a memory card, a USB storage, and a digital camera via a cable, and receives image signals from the image supply devices (not illustrated). The image signal input portion 31 converts the received image signals into image data with a format which can be processed by the image processing portion 32, and outputs the image data to the image processing portion 32.

The image processing portion 32 performs various image quality adjustments such as adjustment of brightness, contrast, sharpness, and shade, or gamma correction, on the image data input from the image signal input portion 31, on the basis of an instruction from the controller 30. The image processing portion 32 outputs the image data having undergone the adjustments and processes to the OSD processing portion 33.

The OSD processing portion 33 performs a process of super imposing an on-screen display (OSD) image such as a menu screen or a message screen on the image data input from the image processing portion 32 on the basis of an instruction from the controller 30. The image data on which the OSD image is superimposed is output to the liquid crystal panel driving portion 34. In a case where there is no instruction for superimposition of an OSD image from the controller 30, the OSD processing portion 33 outputs image data output from the image processing portion 32, to the liquid crystal panel driving portion 34 without being changed.

The power source portion 41 is supplied from the outside with power such, as AC 100 V via a power source terminal 42. The power source portion 41 converts the input power (AC power) into predetermined DC power, and supplies the power to each portion of the projector 1. The power source portion 41 can switch between a state (power on state) in which power (operation power) required to project an image is supplied to each portion, and a state (standby state) in which the supply of the operation power is stopped, and an operation for turning on the power source is awaited, on the basis of an instruction from the controller 30.

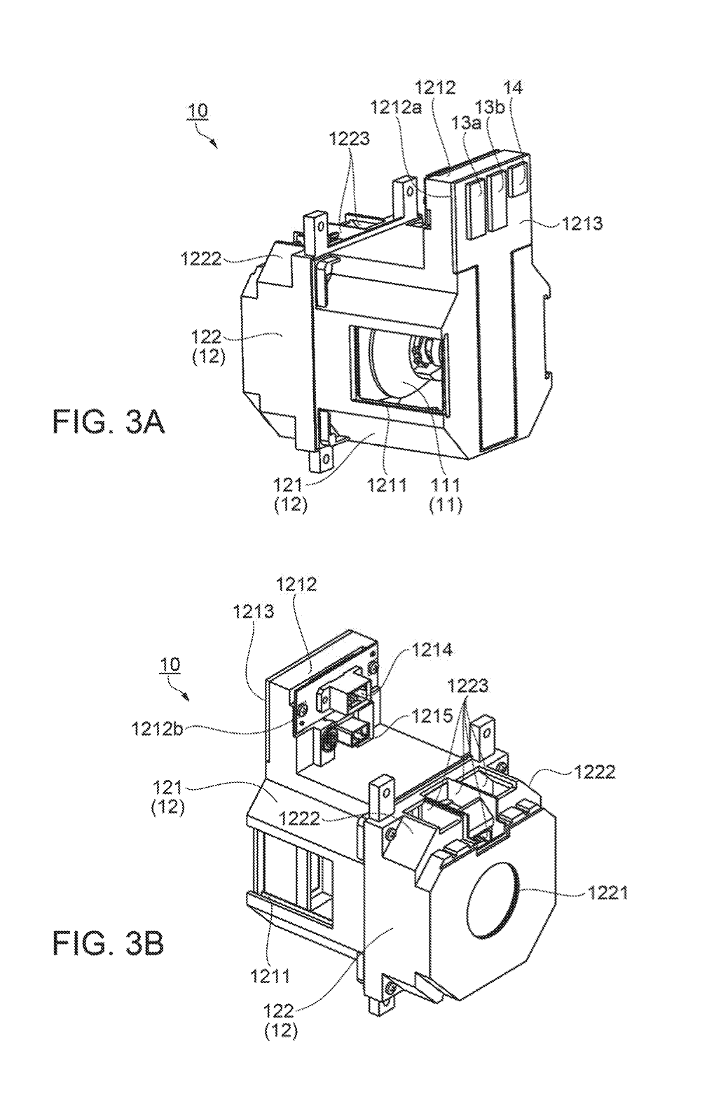

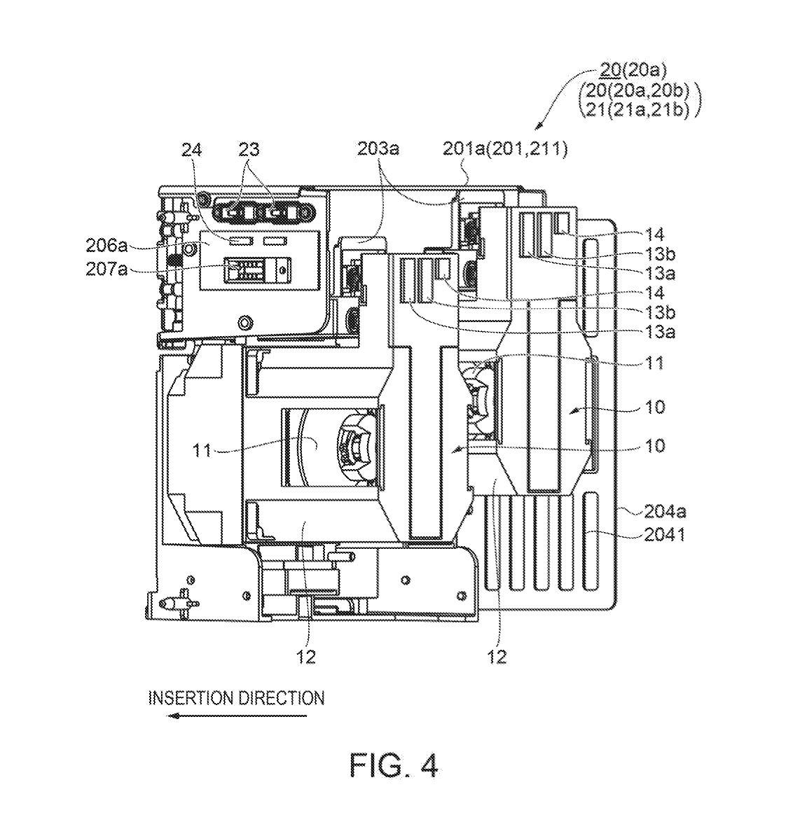

FIGS. 3A and 3B are exterior perspective views of the light source device 10, in which FIG. 3A is a perspective view in which the light source device 10 is viewed from a direction opposite to a light emission direction in the light source 11, and FIG. 3B is a perspective view in which the light source device 10 is viewed from the light emission direction in the light source 11. FIG. 4 is an exterior perspective view of the light source cartridge 20. FIG. 4 is a perspective view in which the light source cartridge 20 is viewed in the direction opposite to the light emission direction in the light source 11. With reference to FIGS. 3A to 4, a description will be made of configurations of the light source device 10 and the light source cartridges 20 and 21.

As illustrated in FIGS. 3A and 3B, the light source device 10 of the present embodiment includes the light source 11 and the light source case 12. In the present embodiment, the light source 11 employs a discharge type lamp as described above. Specifically, the light source 11 includes a light emitting tube (not illustrated) which emits light (light beam), and a reflector 111 which reflects the light emitted from the light emitting tube forward.

The light source case 12 includes a first case 121 which is formed roughly in a box shape and accommodates a rear surface side of the light source 11, and a second case 122 which is formed roughly in a box shape and accommodates a front surface side of the light scarce 11. The light source 11 is fixed in a state of being interposed between the first case 121 and the second case 122. An opening 1211 is formed on a side surface of the first case 121, and thus improves heat dissipation performance of the light source 11. An extension portion 1212 extending upward is formed on an upper part on the rear side of the first case 121.

As illustrated in FIG. 3A, a circuit board 1213 is provided on a rear surf ace 1212a of the extension portion 1212. Two fuses 13a and 13b are mounted on the circuit board 1213. An electrical resistive element as the light source detection portion 14 is mounted on the circuit board 1213. As illustrated in FIG. 3B, a front surface 1212b of the extension portion 1212 is provided with a connector 1214 for making a current flow through the fuses 13a and 13b, a driving connector 1215 for supplying driving power to the light source device 10, and a connector (not illustrated) for making a current flow through the light source detection portion 14.

An opening 1221 through which a light beam emitted from the light source 11 is transmitted is provided at the center on the front side of the second case 122. A plurality of ducts 1223 for introducing cooling air into the light source 11 are provided on an upper surface portion 1222 of the second case 122. The plurality of ducts 1223 which are formed in different flow directions cause cooling air to flow through portions which are desired to be cooled in the light emitting tube.

The light source device 10 having the above configuration can be used in common in any installation posture, regardless of an installation posture of the projector 1.

The light source cartridge illustrated in FIG. 4 is the light source, cartridge 20 for a normal installation posture. Specifically, in a case where the projector 1 is normally installed on the desk surface D, the light source cartridge is the left light source cartridge 20a installed on the left side of the reflection mirror 17 (optical axis C). Therefore, FIG. 4 is a perspective view in which the left light source cartridge 20a is viewed from the front left side.

The light source cartridge is configured to correspond to an installation posture of the projector 1. The light source cartridges of the present embodiment are constituted of two light source cartridges including the light source cartridge 20 for normal installation posture corresponding to a case where the projector 1 is in the normal installation posture and the light source cartridge 21 for the side installation posture corresponding to a case where the projector 1 is in the side installation posture.

The light source cartridge 20 for the normal installation posture includes, as illustrated in FIG. 2, two light source cartridges such as the left light source cartridge 20a installed on the left side of the reflection mirror 17 (optical axis C) and the right light source cartridge 20b installed on the right side thereof. Similarly, for convenience of description, in a case where the projector 1 is normally installed on the desk surface D, the light source cartridge 21 for the side installation posture includes, as illustrated in FIG. 2, two light source cartridges such as the left light source cartridge 21a installed on the left side and the right light source cartridge 21b installed on the right side, as illustrated in FIG. 2.

Therefore, the left light source cartridge 20a (21a) cannot be installed in an accommodation portion (not illustrated) of the right light source cartridge, even if the cartridge is installed therein. This is also the same for a reverse case. The left light source cartridge 20a (21a) and the right light source cartridge 20b (21b) are substantially symmetric to each other with respect to a vertical plane passing through the optical axis C. However, installation positions of the light source devices 10 are not symmetric, and the opposite light source devices 10 are installed at positions which are vertically deviated relative to each other by a predetermined distance.

Since the light source cartridge 21 for the side installation posture is used when the projector 1 is installed in the side installation posture (a posture obtained by rotating the normal installation posture by about 90° with respect to the optical axis C), the left light source cartridge 21a is located on the lower side, and the right light source cartridge 21b is located on the upper side, in the side installation posture.

Hereinafter, for convenience of description, configurations of the light source cartridges 20 and 21 will be described by using the left light source cartridge 20a of the light source cartridge 20 for the normal installation posture as illustrated in FIG. 4.

The left light source cartridge 20a includes a left cartridge case 201a which is formed in a rectangular box shape and accommodates two light source devices 10 arranged side by side. The left cartridge case 201a is provided with a left duct case (not illustrated), a left connector case 203a, and a left heat dissipation plate 204a, and the like. The two light source devices 10 are installed from the rear side and are fixed to the left cartridge case 201a. In this case, the connector 1214 and the connector 1215 are provided in the light source device 10 and are connected to connectors (not illustrated) provided at the connector case 203a.

Two connectors 23 are mounted on the upper side surface of the cartridge case 201, and lead wires connected to the connectors 23 are mounted on a rear surface thereof. The distal ends of the lead wires are connected to a connector (not illustrated), and the connector is connected to the above described connector 1215.

A circuit board 206a is provided under the two connectors 23. An electrical resistive element as the cartridge detection portion 24 is mounted on the circuit board 206a. A plurality of connectors 207a are mounted on the circuit board 206a under the electrical resistive element, and connectors (not illustrated) which are electrically connected to the plurality of connectors 207a are mounted on a rear surface of the circuit board 206a. The rear surface connectors which are electrically connected to the connectors 207a are connected to connectors for the fuses 13a and 13b, a connector for the light source detection portion 14, and the like. The cartridge detection portion 24 is also connected to the connectors 207a.

A direction (insertion direction) in which the left light source cartridge 20a is installed (inserted) in (into) an accommodation portion (not illustrated) inside a main body of the projector 1 is indicated by an arrow in FIG. 4. If the left light source cartridge 20a is installed in the accommodation portion, the plurality of connectors 207a are connected to connectors (not illustrated) provided on the main body side, and can thus be electrically connected to the light source determination portion 301, the cartridge determination portion 302, and the fusing circuit 37 illustrated in FIG. 2. The two connectors 23 for driving the light source device 10 are also inserted into the connectors (not illustrated) provided on the main body side, and can thus be electrically connected to the light source control portion 35.

The duct case (not illustrated) is a member which causes cooling air ejected from the cooling fan 361 provided over the reflection mirror 17 to flow through the light source device 10 corresponding to the cooling fan 361. As described above, in the present embodiment, four cooling fans 361 are provided, and the four cooling fans 361 are respectively provided in the four provided light source devices 10 so as to correspond to each other in a one-to-one relationship. In other words, the single cooling fan 361 is configured to cool the light source 11 of the single corresponding light source device 10.

The duct case is provided with a straightening plate (not illustrated). The straightening plate is a member which restricts an amount of cooling air introduced into the duct 1223 which is provided in the light source device 10 (second case 122). The straightening plate is a member provided in the duct cases of the light source cartridges 20 (20a and 20b) used for the normal installation posture, and is not provided in the duct cases of the light source cartridges 21 (21a and 21b) used for the side installation posture.

The heat dissipation plate 204a is provided on the side surface of the cartridge case 201a. The heat dissipation plate 204a is formed of a metal plate, and is provided with a plurality of slit holes 2041 for improving heat dissipation.

Hitherto, the constituent elements of the light source cartridge have been described by exemplifying the left light source cartridge 20a provided in the light source cartridge 20 for the normal installation posture. Constituent elements of the right light source cartridge 20b are the same as those of the left light source cartridge 20a. However, the constituent elements of the right light source cartridge 20b are symmetric to the constituent elements of the left light source cartridge 20a with respect to the vertical plane passing through the optical axis C. In the same manner as the light source cartridges 20 for the normal installation posture, the light source cartridges 21 for the side installation posture are constituted of the left light source cartridge 21a and the right light source cartridge 21b. Constituent elements of the left and right light source cartridges 21a and 21b are the same as those of the left and right light source cartridges 20a and 20b so as to correspond thereto.

A difference between the light source cartridges 20 for the normal installation posture arid the light source cartridges 21 for the side installation posture is that, as described above, the straightening plate is provided in the duct cases for the normal installation posture but is not provided in the duct cases for the side installation posture.

The reason why the straightening plate is not provided in the duct cases for the side installation posture is as follows. Since the light source cartridge 21 for the side installation posture is used in a posture obtained by rotating the normal installation posture by about 90° with respect to the optical axis C, the left light source cartridge 21a is located on the lower side, and the right light source cartridge 21b is located on the upper side. Therefore, since cooling air for cooling the light source 11 is introduced from a direction parallel to the desk surface D, and thus it is hard to cool the light source 11, it is necessary to introduce a maximum amount of air by removing restriction on the cooling air due to the straightening plate.

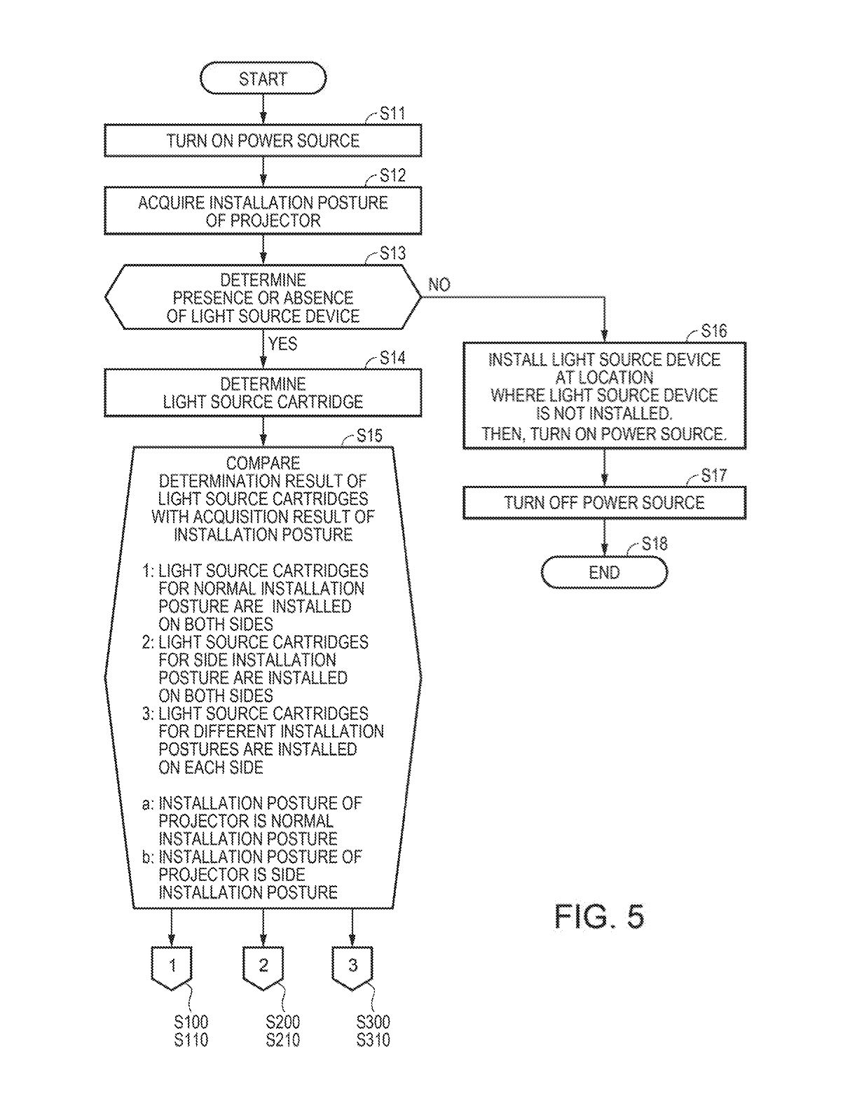

FIG. 5 is a flowchart illustrating an operation after the light source cartridge is attached to the projector 1. With reference to FIG. 5, a description will be made of an operation of the projector 1 after the light source cartridge is attached to the projector 1.

As illustrated in FIG. 5, after the light source cartridge is attached to the projector 1, the user operates the “power key” of the input operation portion 38, and thus the power source is turned on (step S11). In a case where the power source is turned on, the projector 1 is brought into a standby state, and the flow proceeds to step S12.

In step 812, the controller 30 causes the posture detection portion 40 to acquire an installation posture of the projector 1. Next, in step S13, the controller 30 instructs the light source determination portion 301 to determine the presence or absence of the light source device 10. Specifically, the light source determination portion 301 determines the presence or absence of the light source device 10 by making a current flow through the light source, detection portion 14 provided in the light source device 10 so as to detect output therefrom. In step S13, in a case where it is determined that the light source device 10 is attached (YES in step S13), the flow proceeds to step S14, and, in a case where it is determined that the light source device 10 is not attached (NO in step S13), the flow proceeds to step S16.

In step S14, the controller 30 instructs the cartridge determination portion 302 to determine a corresponding installation posture of the installed light source cartridges. Specifically, the cartridge determination portion 302 determines a corresponding installation posture of the light source cartridges by making a current flow through the cartridge detection portions 24 provided in the light source cartridges so as to detect an output difference.

In step S15, the controller 30 determines a subsequent transition flow by comparing the determination result of the light source cartridges with the acquisition result of the installation posture. Specifically, in a case where the light source cartridges are to be installed, there are three ways of installing the light source cartridges, such as, specifically, (1) a case where the light source cartridges for the normal installation posture are installed on both sides (left and right sides) (the light source cartridges 20 are installed on the left and right sides), (2) a case where the light source cartridges for the side installation posture are installed on both sides (left and right sides) (the light source cartridges 21 are installed on the left and right sides), and (3) a case where the light source cartridges for different installation postures are installed on each side (on each of the left and right sides) (for example, the light source cartridges 20 for the normal installation posture are installed on the left side, and the light source cartridges 21 for the side installation posture are installed on the right side). For the three ways of installing the light source cartridges, there are two ways of installation postures of the projector 1, such as (a) the normal installation posture and (b) the side installation posture.

In step S15, in a case where the light source cartridges for the normal installation posture are installed on both sides, the flow proceeds to steps S100 and S110. In a case where the light source cartridges for the side installation posture are installed on both sides, the flow proceeds to steps S200 and S210, and, in a case where the light source cartridges for different installation postures are installed on each side, the flow proceeds to steps S300 and S310.

In a case where it is determined that the light source device 10 is not installed in step S13, the flow proceeds to step S16. In step S16, the controller 30 causes the notification portion 39 to display a message image with the content that “install a light source device at a location where the light source device is not installed; and then turn on the power source”.

Thereafter, in step S17, the controller 30 turns off the power source, and finishes the process in step S18. The user confirms the message image, detaches the cover member 1B, extracts the light source cartridges, and installs the light source device 10 at a location where the light source device 10 is not installed. Then, the user attaches the light source cartridges and the cover member 1B again. Successively, the user turns on the power source in step S11.

In the present embodiment, there is a specification in which four light source devices 10 are all installed. This is because of characteristics of the reflection mirror 17 of the present embodiment. The reflection mirror 17 ideally completely reflects incident light, but transmits light therethrough to some degree. The light source devices 10 of the present embodiment are provided to be opposite to each other with the reflection mirror 17 interposed therebetween. Therefore, in a case where either of the light source devices 10 is not provided, when the opposite light source device 10 is lighted, emitted light is transmitted through the reflection mirror 17. The transmitted light passes through the region of the light source device 10 which should be installed so as to be applied to peripheral members (for example, a synthetic resin member with low heat resistance). Therefore, since the four light source devices 10 are all installed, it is possible to prevent transmitted light from causing an irradiated member to generate heat and thus a material thereof to be deteriorated.

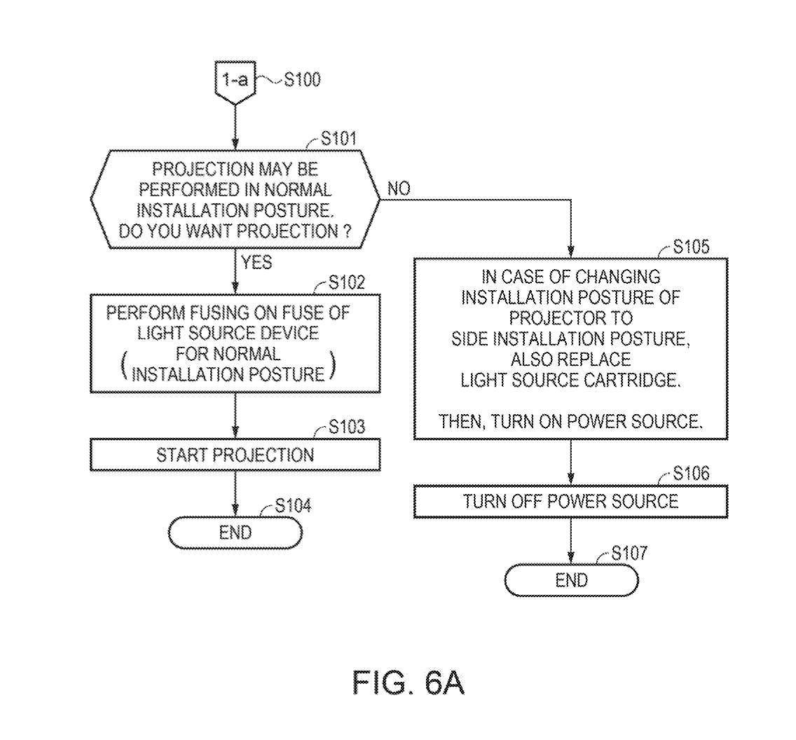

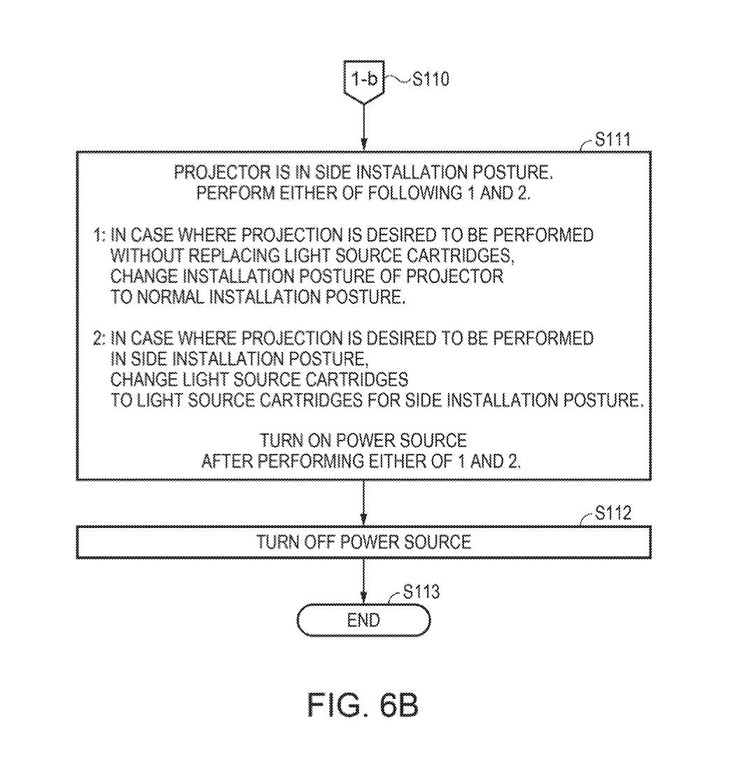

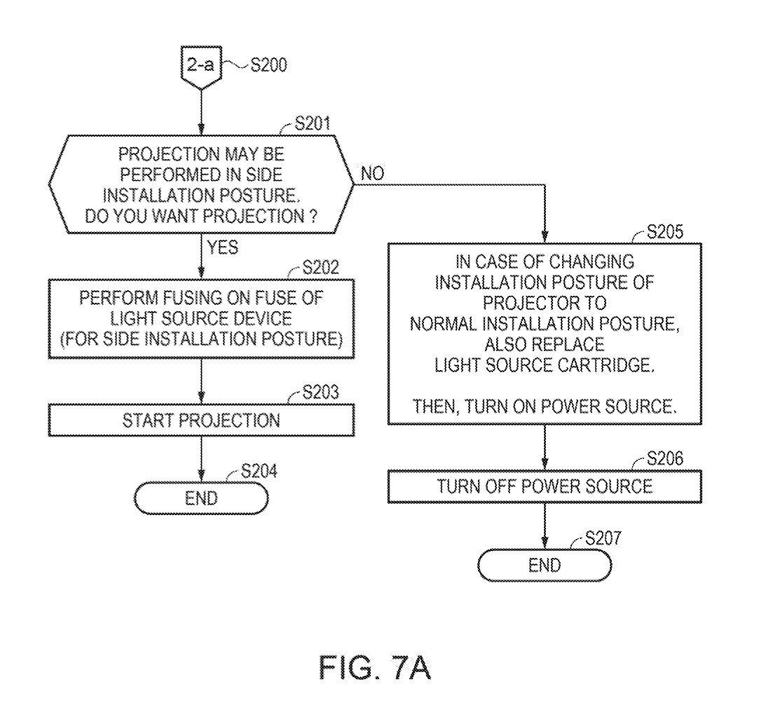

FIGS. 6A and 6B are flowcharts illustrating the case (steps S100 and S110) where the light source cartridges for the normal installation posture are installed on both sides, in which FIG. 6A is a flowchart illustrating a case where an installation posture of the projector 1 is the normal installation posture, and FIG. 6B is a flowchart illustrating a case where an installation posture of the projector 1 is the side installation posture. With reference to FIGS. 6A and 6B, a description will be made of the case where the light source cartridges for the normal installation posture are installed on both sides.

As illustrated in FIG. 6A, in the case where the light source cartridges (light source cartridges 20) for the normal installation posture are installed on both sides, and an installation posture of the projector 1 is the normal installation posture, the flow proceeds to step S100 from step S15, and then proceeds to step S101.

In step S101, the controller 30 causes the notification portion 33 to display a message image with the content that “projection may be performed in the normal installation posture; do you want projection?”. The user confirms the message image, and operates an input key of the input operation portion 38 for performing projection in a case where projection is performed without being changed (YES in step S101). Consequently, the flow proceeds to step S102. In a case where projection is not performed, the user operates an input key of the input operation portion 38 for not performing projection (NO in step S101). Consequently, the flow proceeds to step S105.

In a case where the flow proceeds to step S102 from step S101, the controller 30 instructs the fusing circuit 37 to fuse the fuse 13a for the normal installation posture installed in each light source device 10, and then flow proceeds to step S103. In step S103, the controller 30 instructs the light source control portion 35 to start driving of the light source device 10 and thus to start projection. The flow proceeds to step S104, and the flowchart is finished. Consequently, the projector 1 starts projection in the normal installation posture.

Here, if the input key operation (YES) for project ion is performed on the input operation portion 38 in step S101, an operation for operating the fusing circuit 37 is regarded to be received. The controller 30 gives an instruction for fusing the fuse 13a corresponding to the normal installation posture to the fusing circuit 37 on the basis of a result detected by the cartridge detection portion 24 and the input operation from the input operation portion 38.

In a case where the flow proceeds to step S105 from step S101, the controller 30 causes the notification portion 39 to display a message image with the content that “in a case of changing an installation posture of the projector to the side installation posture, also replace the light source cartridge; and then turn on the power source”.

Thereafter, in step S106, the controller 30 turns off the power source, and finishes the process in step S107. In a case where the user confirms the message image, and changes an installation posture of the projector 1 to the side installation posture, the user replaces the light source cartridges 20 with the light source cartridges 21 for the side installation posture, and then installs the projector 1 again to be in the side installation posture. Thereafter, the flow is started from step S11 (turn on the power source) illustrated in FIG. 5.

As illustrated in FIG. 6B, in the case where the light source cartridges (light source cartridges 20) for the normal installation posture are installed on both sides, and an installation posture of the projector 1 is the side installation posture, the flow proceeds to step S110 from step S15, and then proceeds to step S111.

In step S111, the controller 30 causes the notification portion 39 to display a message image with the content that “the projector is in the side installation posture; perform either of the following 1 and 2”. In addition, the controller 30 causes the notification portion 39 to display a message image with the content that “1: in a case where projection is desired to be performed without replacing the light source cartridges, change an installation posture of the projector to the normal installation posture, and 2: in a case where projection is desired to be performed in the side installation posture, change the light source cartridges to light source cartridges for the side installation posture; and turn on the power source after performing either of 1 and 2”. Thereafter, in step S112, the controller 30 turns off the power source, and finishes the process in step S113.

In a case where the user confirms the message image in step S111, and desires to perform projection without changing the light source cartridges 20 (for the normal installation posture) as in the above 1, the user installs the projector 1 again so that an installation posture thereof is changed from the present side installation posture to the normal installation posture. Thereafter, the flow is started from, step S11 (turn on the power source) illustrated in FIG. 5. In a case where the user desires to perform projection without changing an installation posture (side installation posture) of the projector 1 as in the above 2, the user replaces the currently installed light source cartridges 20 (for the normal installation posture) with the light source cartridges 21 (for the side installation posture). Thereafter, the flow is started from step S11 (turn on the power source) illustrated in FIG. 5.

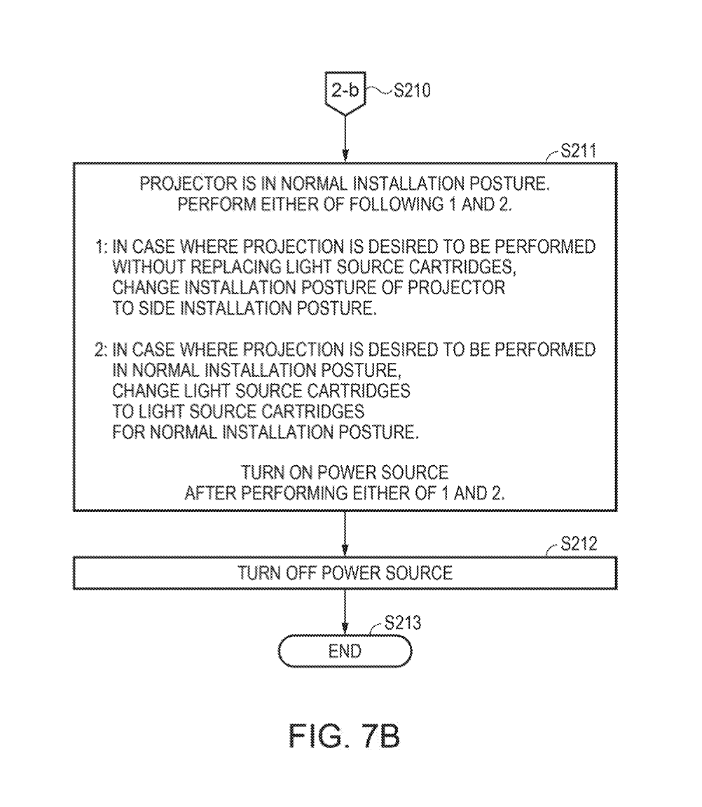

FIGS. 7A and 7B are flowcharts illustrating the case (steps S200 and S210) where the light source cartridges for the side installation posture are installed on both sides, in which FIG. 7A is a flowchart illustrating a case where an installation posture of the projector 1 is the side installation posture, and FIG. 7B is a flowchart illustrating a case where an installation posture of the projector 1 is the normal installation posture. With reference to FIGS. 7A and 7B, a description will be made of the case where the light source cartridges for the side installation posture are installed on both sides.

As illustrated in FIG. 7A, in the case where the light source cartridges (light source cartridges 21) for the side installation posture are installed on both sides, and an installation posture of the projector 1 is the side installation posture, the flow proceeds to step S200 from step S15, and then proceeds to step S201.

In step S201, the controller 30 causes the notification portion 39 to display a message image with the content that “projection may be performed in the side installation posture; do you want projection?”. The user confirms the message image, and operates an input key of the input operation portion 38 for performing projection in a case where projection is performed without being changed (YES in step S201). Consequently, the flow proceeds to step S202. In a case where projection is not performed, the user operates an input key of the input operation portion 38 for not performing projection (NO in step S201). Consequently, the flow proceeds to step S205.

In a case where the flow proceeds to step S202 from step S201, the controller 30 fuses the fuse 13b for the side installation posture installed in each light source device 10, and then flow proceeds to step S203. In step S203, the controller 30 instructs the light source control portion 35 to start driving of the light source device 10 and thus to start projection. The flow proceeds to step S204, and the flowchart is finished. Consequently, the projector 1 starts projection in the side installation posture.

In a case where the flow proceeds to step S205 from step S201, the controller 30 causes the notification portion 39 to display a message image with the content that “in a case of changing an installation posture of the projector to the normal installation posture, also replace the light source cartridge; then, turn on the power source”.

Thereafter, in step S206, the controller 30 turns off the power source, and finishes the process in step S207. In a case where the user confirms the message image, and changes an installation posture of the projector 1 to the normal installation posture, the user replaces the light source cartridges 21 with the light source cartridges 20 for the normal installation posture, and then installs the projector 1 again to be in the normal installation posture. Thereafter, the flow is started from step S11 (turn on the power source) illustrated in FIG. 5.

As illustrated in FIG. 7B, in the case where the light source cartridges (light source cartridges 21) for the side installation posture are installed on both sides, and an installation posture of the projector 1 is the normal installation posture, the flow proceeds to step S210 from step S15, and then proceeds to step S211.

In step S211, the controller 30 causes the notification portion 39 to display a message image with the content that “the projector is in the normal installation posture; perform either of the following 1 and 2”. In addition, the controller 30 causes the notification portion 39 to display a message image with the content that “1: in a case where projection is desired to foe performed without replacing the light source cartridges, change an installation posture of the projector to the side installation posture, and 2: in a case where projection is desired to be performed in the normal installation posture, change the light source cartridges to light source cartridges for the normal installation posture; and turn on the power source after performing either of 1 and 2”. Thereafter, in step S212, the controller 30 turns off the power source, and finishes the process in step S213.

In a case where the user confirms the message image in step S211, and desires to perform projection without replacing the light source cartridges 21 (for the side installation posture) as in the above 1, the user installs the projector 1 again so that an installation posture thereof is changed from the present normal installation posture to the side installation posture. Thereafter, the flow is started from, step S11 (turn on the power source) illustrated in FIG. 5. In a case where the user desires to perform projection without changing an installation posture (normal installation posture) of the projector 1 as in the above 2, the user replaces the currently installed light source cartridges 21 (for the side installation posture) with the light, source cartridges 20 (for the normal installation posture). Thereafter, the flow is started from step S11 (turn on the power source) illustrated in FIG. 5.

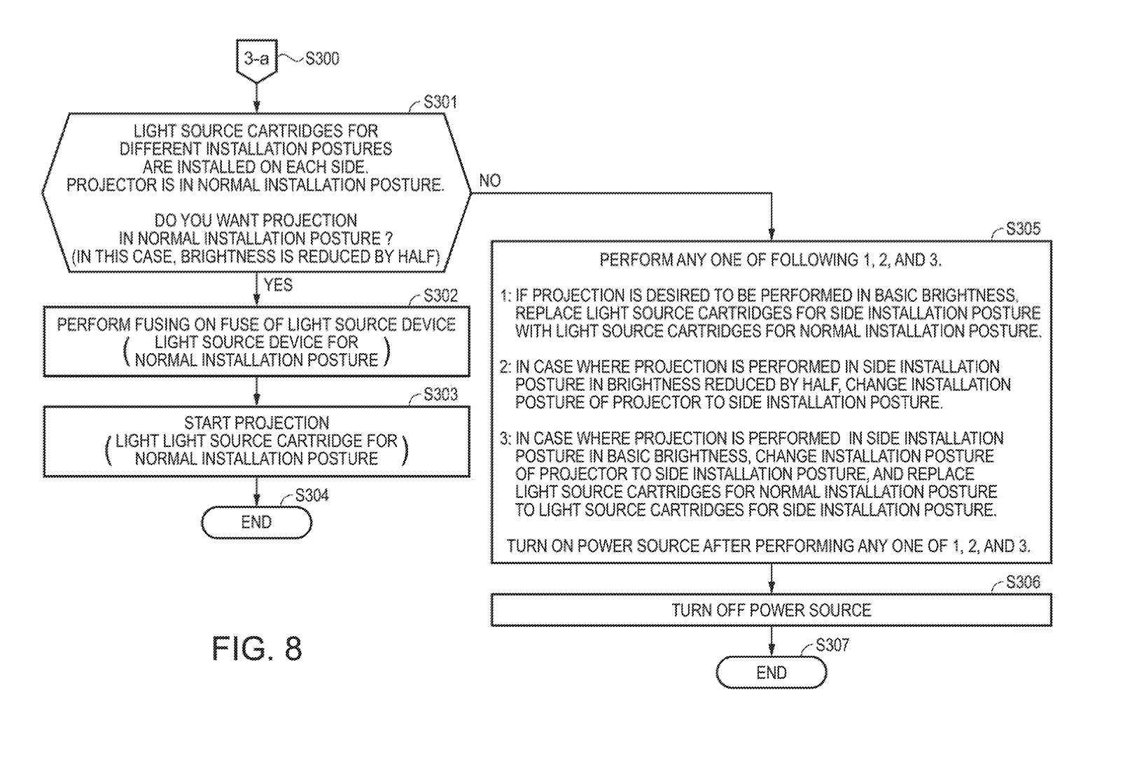

FIG. 8 is a flow-chart illustrating the case where the light source cartridges for different installation postures are installed on each side, and an installation posture of the projector 1 is the normal installation posture. With reference to FIG. 8, a description will be made of the case where the light source cartridges for different installation postures are installed on each side.

As illustrated in FIG. 8, in the case where the light source cartridges for different installation postures are installed on each side (for example, the light source cartridges 20 for the normal installation posture are installed on the left side, and the light source cartridges 21 for the side installation posture are installed on the right side), and an installation posture of the projector 1 is the normal-installation posture, the flow proceeds to step S300 from step S15, and then proceeds to step S301.

In step S301, the controller 30 causes the notification portion 39 to display a message image with the content that “the light source cartridges for different installation postures are installed on each side; the projector is in the normal installation posture; do you want projection in the normal installation posture? (in this case, brightness is reduced by half)”. The user confirms the message image, and operates an input key of the input operation portion 38 for performing projection in a case where projection is performed without being changed (YES in step S301). Consequently, the flow proceeds to step S302. In a case where projection is not performed, the user operates an input key of the input operation portion 38 for not performing projection (NO in step S301). Consequently, the flow proceeds to step S305.

In a case where the flow proceeds to step S302 from step S301, the controller 30 fuses the fuse 13a for the normal installation posture installed in each light source device 10 accommodated in the light source cartridge 20 for the normal installation posture, and then flow proceeds to step S303.

In step S303, the controller 30 instructs the light source control portion 35 to start driving of the light source device 10 accommodated in the light source cartridge 20 for the normal installation posture and thus to start projection. The flow proceeds to step S304, and the flowchart is finished. Consequently, the projector 1 starts projection in the normal installation posture. However, the brightness (luminance) of an image projected from the projector 1 is reduced to a half of the basic brightness in a case where both sides are lighted, since only the light source cartridges 20 installed on one side (for example, the left side) are lighted.

In a case where the flow proceeds to step S305 from step S301, the controller 30 causes the notification portion 39 to display a message image with the content that “perform any one of the following 1, 2, and 3”. In addition, the controller 30 causes the notification portion 39 to display a message image with the content that “1: if projection is desired to foe performed in the basic brightness, replace the light source cartridges for the side installation posture with the light source cartridges for the normal installation posture, 2: in a case where projection is performed in the side installation posture in the brightness reduced by half, change an installation posture of the projector to the side installation posture, and 3: in a case where projection is performed in the side installation posture in the basic brightness, change an installation posture of the projector to the side installation posture, and replace the light source cartridges for the normal installation posture to the light source cartridges for the side installation posture; and turn on the power source after performing any one of 1, 2, and 3”. Thereafter, in step S306, the controller 30 turns off the power source, and finishes the process in step S307.

If the user confirms the message image in step S305, and desires to perform projection, in the basic brightness as in the above 1, the user replaces the light source cartridges 21 for the side installation posture with the light source cartridges 20 for the normal installation posture. Thereafter, the flow is started from step S11 (turn on the power source) illustrated in FIG. 5. In a case where the user performs projection in the brightness reduced by half (by using the light source cartridges 21 for the side installation posture) in the side installation posture as an installation posture of the projector 1 as in the above 2, the user installs the projector 1 again so that an installation posture thereof is changed from the present normal installation posture to the side installation posture. Thereafter, the flow is started from step S11 (turn on the power source) illustrated in FIG. 5. In a case where the user performs projection in the basic brightness in the side installation posture as an installation posture of the projector 1 as in the above 3, the user installs the projector 1 again so that an installation posture thereof is changed from the present normal installation posture to the side installation posture. In addition, the user replaces the currently installed light source cartridges 20 (for the normal installation posture) with the light source cartridges 21 (for the side installation posture). Thereafter, the flow is started from step S11 (turn on the power source) illustrated in FIG. 5.

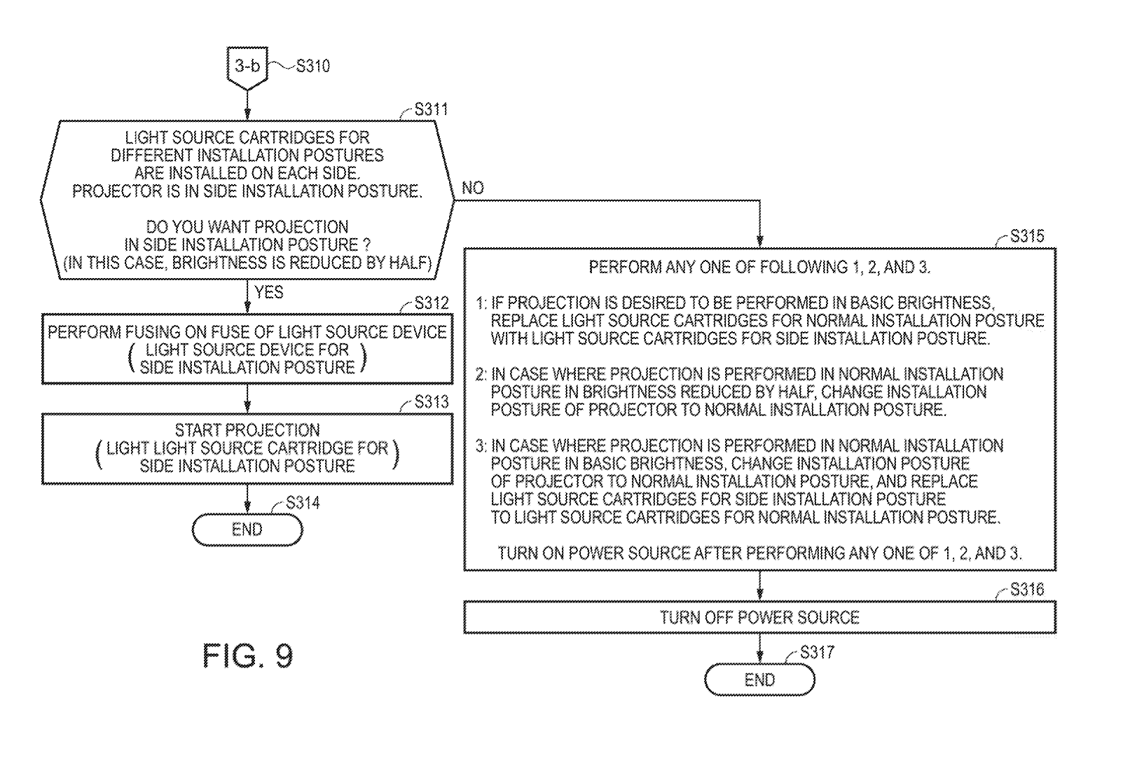

FIG. 9 is a flowchart illustrating the case where the light source cartridges for different installation postures are installed on each side, and an installation posture of the projector 1 is the side installation posture. With reference to FIG. 9, a description will be made of the case where the light source cartridges for different installation postures are installed on each side.

As illustrated in FIG. 9, in the case where the light source cartridges for different installation postures are installed on each side (for example, the light source cartridges 20 for the normal installation posture are installed on the left side, and the light source cartridges 21 for the side installation posture are installed on the right side), and an installation posture of the projector 1 is the side installation posture, the flow proceeds to step S310 from step S15, and then proceeds to step S311.

In step S311, the controller 30 causes the notification portion 33 to display a message image with the content that “the light source cartridges for different installation postures are installed on each side; the projector is in the side installation posture; do you want projection in the side installation posture? (in this case, brightness is reduced by half)”. The user confirms the message image, and operates an input key of the input operation portion 38 for performing projection in a case where projection is performed without being changed (YES in step S311). Consequently, the flow proceeds to step S312. In a case where projection is not performed, the user operates an input key of the input operation portion 38 for not performing projection (NO in step S311). Consequently, the flow proceeds to step S315.

In a case where the flow proceeds to step S312 from step S311, the controller 30 fuses the fuse 13b for the side installation posture installed in each light source device 10 accommodated in the light source cartridge 21 for the side installation posture, and then flow proceeds to step S313.

In step S313, the controller 30 instructs the light source control portion 35 to start driving of the light source device 10 accommodated in the light source cartridge 21 for the side installation posture and thus to start projection. The flow proceeds to step S314, and the flowchart is finished. Consequently, the projector 1 starts projection in the side installation posture. However, the brightness (luminance) of an image projected from the projector 1 is reduced to a half of the basic brightness in a case where both sides are lighted, since only the light source cartridges 21 installed on one side (for example, the right side) are lighted.

In a case where the flow proceeds to step S315 from step S311, the controller 30 causes the notification portion 39 to display a message image with the content that “perform any one of the following 1, 2, and 3”. In addition, the controller 30 causes the notification portion 33 to display a message image with the content that if projection is desired to be performed in the basic brightness, replace the light source cartridges for the normal installation posture with the light source cartridges for the side installation posture, 2: in a case where projection is performed in the normal installation posture in the brightness reduced by half, change an installation posture of the projector to the normal installation posture, and 3: in a case where projection is performed in the normal installation posture in the basic brightness, change an installation posture of the projector to the normal installation posture, and replace the light source cartridges for the side installation posture to the light source cartridges for the normal installation posture; and turn on the power source after performing any one of 1, 2, and 3”. Thereafter, in step S316, the controller 30 turns off the power source, and finishes the process in step S317.

If the user confirms the message image in step S315, and desires to perform projection in the basic brightness as in the above 1, the user replaces the light source cartridges 20 for the normal installation posture with the light source cartridges 21 for the side installation posture. Thereafter, the flow is started from step S11 (turn on the power source) illustrated in FIG. 5. In a case where the user performs projection in the brightness reduced by half (by using the light source cartridges 20 for the normal installation posture) in the normal installation posture as an installation posture of the projector 1 as in the above 2, the user installs the projector 1 again so that an installation posture thereof is changed from the present side installation posture to the normal installation posture. Thereafter, the flow is started from step S11 (turn on the power source) illustrated in FIG. 5. In a case where the user performs projection in the basic brightness in the normal installation posture as an installation posture of the projector 1 as in the above 3, the user installs the projector 1 again so that an installation posture thereof is changed from the present side installation posture to the normal installation posture. In addition, the user replaces the currently installed light source cartridges 21 (for the side installation posture) With the light source cartridges 20 (for the normal installation posture). Thereafter, the flow is started from step S11 (turn on the power source) illustrated in FIG. 5.

According to the above-described embodiment, the following effects can be achieved.

According to the present embodiment, the light source device 10 includes the light source 11 and the light source case 12 accommodating the light source 11. The light source case 12 includes a plurality of fuses (the fuse 13a for the normal installation posture and the fuse 13b for the side installation posture) which are fused in a case where the light source device 10 is in a used state. The light, source case 12 includes the light source detection portion 14 which detects whether or not the light source device 10 is installed at a predetermined position in the projector 1. With this simple configuration, a user can understand an installation posture of the light source device 10 when the light source device 10 was used by visually checking which fuse is fused of the fuse 13a (for the normal installation posture) and the fuse 13b (for the side installation posture). Thus, this can help the user to understand a replacement time of the light source device 10. Since the light source detection portion 14 detects whether or not the light source device 10 is installed at a predetermined position in the projector 1, it is possible to detect whether or not the light source device 10 is accurately installed.

According to the projector 1 of the present embodiment, the light source cartridge 20 corresponds to the normal installation posture of the projector 1, and the light source cartridge 20 includes the left light source cartridge 20a and the right light source cartridge 20b. The left light source cartridge 20a includes the left cartridge case 201a. The right light source cartridge 20b includes the right cartridge case 201b. Two light source devices 10 are accommodated in each of the cartridge cases 201a and 201b. A configuration of the light source cartridge 21 for the side installation posture is substantially the same as the configuration of the light source cartridge 20 for the normal installation posture.

In the projector 1, the cartridge detection portion 24 detects corresponding installation postures (the normal installation posture and the side installation posture) of the light source cartridges 20 and 21. Thus, it is possible to determine whether or not the light source cartridges 20 and 21 corresponding to an installation posture of the projector 1 are installed on the basis of a detection result in the cartridge detection portion 24 and an acquisition result of the installation posture of the projector 1.

In a case of using the light source cartridges 20 and 21, the user visually checks the fused fuses 13a and 13b of the light source devices 10 accommodated in the light source cartridges 20 and 21 and can thus understand whether the light source devices 10 (the light source cartridges 20 and 21) were used previously in the normal installation posture or in the side installation posture. This can help the user to understand a replacement time of the light source devices 10 (the light source cartridges 20 and 21).

According to the present embodiment, the projector 1 includes the controller 30 which controls an operation of the projector 1 on the basis of results detected by the light source detection portion 14 and the cartridge detect ion portion 24, and the notification portion 39 which performs a notification based on a process performed by the controller 30. Consequently, the notification portion 39 performs a notification of a result of the process performed by the controller 30 on the basis of the results detected by the light source detection portion 14 and the cartridge detect ion port ion 24, Therefore, for example, the user can check whether or not the light source device 10 is installed, and whether or not the light source cartridges 20 and 21 corresponding to an installation posture of the projector 1 are installed, via the notification portion 39.

According to the present embodiment, the projector 1 includes the fusing circuit 37 which fuses the fuses 13a and 13b; the input operation portion 38 which receives an operation (an input operation corresponding to. “YES” in steps S101, S201, S301, and S311) for operating the fusing circuit 37; and the controller 30 which gives the fusing circuit 37 an instruction for fusing the fuses 13a and 13b corresponding to an installation posture on the basis of a result detected by the cartridge detection portion 24 and an input operation from the input operation portion 38, With this configuration, the controller 30 gives the fusing circuit 37 an instruction for fusing the fuses 13a and 13b corresponding to an installation posture on the basis of the result detected by the cartridge detection portion 24 and the input operation from the input operation portion 38. Consequently, the user can check whether or not the light source cartridges 20 and 21 corresponding to an installation posture of the projector 1 are installed. In a case where the corresponding light source cartridges 20 and 21 are installed, the fuses 13a and 13b corresponding to the installation posture can also be fused.

According to the projector 1 of the present embodiment, installation postures of the projector 1 are the normal installation posture corresponding to on-desk installation or hanging installation, and the side installation posture obtained by rotating the normal installation posture by about 90° with respect to the optical axis C of light emitted from the projection optical device 19. Consequently, the appropriate light source cartridges 20 and 21 can be installed in the normal installation posture and the side installation posture so as to perform projection. A horizontally long image (for example, a lateral image with the A4 size) can be projected in the normal installation posture without being reduced, and a vertically long image (for example, a longitudinal image with the A4 size) can be projected in the side installation posture without being reduced. Therefore, it is possible to improve convenience of the projector 1.

According to the projector 1 of the present embodiment, the cartridge detection portion 24 and the light source detection portion 14 are configured to include electrical resistive elements, and thus it is possible to easily configure the cartridge detection portion 24 and the light source detection portion 14.

According to the projector 1 of the present embodiment, as described above, the user visually checks a state in which the fuses 13a and 13b provided in the light source devices 10 are fused so as to understand an installation posture in which the light source device 10 was used, and can thus be helped to understand a replacement time of the light source device 10. The user can judges whether of not the light source device 10 is a new product by visually checking whether the fuses 13a and 13b are in a conduction state or a fused state.

According to the projector 1, the light source cartridges 20 and 21 respectively include the corresponding cartridge cases 201 and 211 on the left and right sides, and two light source devices 10 are accommodated in each of the cartridge cases 201 and 211. The light source devices 10 are attachable to and detachable from the light source cartridges 20 and 21 (cartridge cases 201 and 211). Consequently, in a case where any one of the light source devices 10 deteriorates, the light source device 10 can be replaced with a new light source device 10. Therefore, it is possible to improve convenience of the light source cartridges 20 and 21.

According to the projector 1 of the present embodiment, the light source cartridges 20 and 21 include the connectors for supplying power to the light source device 10, the connectors connecting the fuses 13a and 13b to the fusing circuit 37, the connectors connecting the light source detection portion 14 to the light source determination portion 301, the connectors connecting the cartridge detection portion 24 to the cartridge determination portion 302, and the like, and are thus attachable to and detachable from the main body of the projector 1. The light source cartridges 20 and 21 are attached at predetermined positions so that the respective connectors are set in and are electrically connected to the connectors of the main body side of the projector 1, and thus it is possible to improve convenience of the light source cartridges 20 and 21.

According to the projector 1 of the present embodiment, in a case where the light source device 10 was used, it is possible to specify whether the light source device 10 was used in the normal installation posture or the side installation posture. In the projector 1 of the present embodiment, it is hard to specify an available time being left till a service life of the used light source device 10. In order to specify the left available time, a storage portion storing the left available time may be provided in the light source device 10, but, since a plurality of light source devices 10 are used, and the temperature of the light source device 10 is high, it is necessary to provide a structure of preventing operation errors of the, storage portion or countermeasures for safety. Therefore, a mechanical configuration or an electrical circuit system or control system naturally becomes complex. When taking this matter into consideration, as in the present embodiment, there are a lot of advantages in that a replacement time of the light source device 10 can be understood with the simple configuration.

The invention is not limited to the above-described embodiment, and may be implemented by adding various modifications, alterations, or the like to the embodiment within the scope without departing from the spirit thereof. Hereinafter, modification examples will foe described.

In the projector 1 of the embodiment, an on-desk installation posture has been described as the normal installation posture, but the invention is not limited thereto, and the projector 1 may be in a hanging posture. Fundamentally, in the on-desk installation posture, the optical axis C of light projected from the projection optical device 19 is parallel to the desk surface D, but the invention is not limited thereto, and an installation posture may be used in which the optical axis C vertically has an angle with respect to the desk surface D. An installation posture (so-called upward projection installation posture) in which the optical axis C has about 90° with respect to the desk surface D, or an installation posture (so-called downward projection installation posture) in which the optical axis C has about −90° may be used. The same effect as in the present embodiment can also be achieved in a projector which is installed in such a posture.

The projector 1 of the embodiment is based on a light source cartridge corresponding to an installation posture of the projector 1 being used. However, the light source cartridges 21 (21a and 21b) for the side installation posture do not include a straightening plate for restricting an amount of cooling air in the duct cases (cartridge cases 211 (211a and 211b)), and can thus sufficiently cool the light source 11 even in a case of being used in the normal installation posture. Therefore, the light source cartridges 21 for the side installation posture may also be used in the normal installation posture. In this case, preferably, the controller 30 executes a fan driving program corresponding to a case where the projector 1 is in the normal installation posture, and a light source cartridge is the light source cartridge 21 for the side installation posture, so that the fan control portion 36 drives the fans, and thus the temperature of the light source 11 is managed.

In the projector 1 of the embodiment, the light source cartridges 20 and 21 are configured so that a single light source cartridge includes two light source devices 10. However, a single light source cartridge may include three or more light source devices 10.

In the projector 1 of the embodiment, in which posture the light source device 10 was used can be specified on the basis of which one of the fuses 13a and 13b is fused. However, instead of the fuses, a film-like pressure detection member which detects applied pressure may be provided. Here, in a case where the light source device 10 is lighted, a pressing mechanism which presses a corresponding pressure detection member is provided, and it is possible to specify in which posture the light source device 10 was used by checking a color or the like of a pressed region of the pressure detection member.

The light source device 10 of the embodiment uses a discharge type lamp as the light source 11, and uses, specifically, an ultra-high pressure mercury lamp, a metal halide lamp, or the like. However, the invention is not limited thereto, and various solid-state light emitting elements such as a laser diode, a light emitting diode (LED), an organic electroluminescent (EL) element, and a silicon light emitting element may be used.

In the projector 1 of the embodiment, as a light modulation device, the transmissive light modulation device (transmissive liquid crystal panel 18) is used. However, the invention is not limited thereto, and a reflective light modulation device may be used.

In the projector 1 of the embodiment, the liquid crystal panel 18 is used as a light modulation device. However, the invention is not limited thereto, and, light modulation devices such as a micromirror type light modulation device may be generally used as long as an incident light beam is modulated on the basis of an image signal. For example, a digital micromirror device (DMD) may be used as the micromirror type light modulation device.

In the projector 1 of the embodiment, the optical system 2 uses the lens integrator optical system in order to uniformize the illuminance of light (light beam) emitted from the light source device 10. However, the invention is not limited thereto, and a rod integrator optical system constituted of a light guiding rod may be used.

What is claimed is:

1. A light source device which is incorporated into a projector including a cooling device sending cooling air and is used, the light source device comprising:
a light source; and
a light source case that accommodates the light source,
wherein the light source case includes
a plurality of ruses that are fused in a case where the light source device is in a predetermined use state; and
a light source detection portion that detects whether or not the light source device is installed at a predetermined position in the projector.

2. A projector comprising;
a light modulation device that modulates light emitted from a light source;
a projection optical device that projects the light modulated by the light modulation device; and
a plurality of light source cartridges that include the light source device according to claim 1, and a cartridge case accommodating a plurality of the light source devices and corresponding to an installation posture of a projector main body,
wherein the cartridge case includes a cartridge detection portion that detects the corresponding installation posture.

3. The projector according to claim 2, further comprising:
a controller that controls an operation of the projector main body on the basis of results detected by the light source detection portion and the cartridge detection portion; and
a notification portion that performs a notification based on a process performed by the controller.

4. The projector according to claim 2, further comprising:
a fusing circuit that fuses the fuse;
an input operation portion that receives an operation for operating the fusing circuit; and
a controller that gives an instruction for fusing the fuse corresponding to the installation posture to the fusing circuit on the basis of a result detected by the cartridge detection portion and an input operation from the input operation portion.

5. The projector according to claim 2,
wherein the installation posture includes a normal installation posture corresponding to on-desk installation or hanging installation, and a side installation posture obtained by rotating the normal installation posture by about 90° with respect to an optical axis of light emitted from the projection optical device.

6. The projector according to claim 2,
wherein the cartridge detection portion and the light source detection portion are configured to include electrical resistive elements.
